(19) United States
(12) Patent Application Publication
(10) Pub. No.: US 2009/0268088 A1
(43) Pub. Date: Oct. 29, 2009

(54) MOTION ADAPTIVE DE-INTERLACER AND METHOD FOR USE THEREWITH

(76) Inventor: Hui Zhou, Toronto (CA)

Correspondence Address: GARLICK HARRISON & MARKISON, P.O. BOX 160727, AUSTIN, TX, 78716-0727, US

(21) Appl. No.: 12/109,815

(22) Filed: Apr. 25, 2008

(51) Int. Cl. H04N 7/01

(52) U.S. Cl. 348/452; 348/E07.003

(57) ABSTRACT

A deinterlacer includes an interpolation module, coupled to receive a video signal and a motion map, that generates a deinterlaced video signal. The interpolation module includes a spatial interpolation module that generates a spatially interpolated video signal having first pixel values and a temporal interpolation module that generates a temporally interpolated video signal having second pixel values. The interpolation module generates the deinterlaced video signal based on the first pixel values when corresponding pixel motion values of the motion map are within a first range of values and that generates the deinterlaced video signal based on the second pixel values when the corresponding pixel motion values of the motion map are within a second range of values.

### CROSS REFERENCE TO RELATED PATENTS

Not applicable

### TECHNICAL FIELD OF THE INVENTION

The present invention relates to de-interlacing used in video devices.

### DESCRIPTION OF RELATED ART

Many video signals are processed in an interlaced format where frames of video signals are separated into odd and even fields that are alternately displayed to produce the illusion of a single image. For example, in NTSC standard video signals, odd and even fields are interlaced every 60^{th} of a second to produce frames at an overall rate of 30 frames per second. In addition, other standard video formats are interlaced such as 480i 720i, 1080i, etc. Deinterlacing is the process of reconstructing whole frames from interlaced frames, for instance when an interlaced signal is converted to a progressive scan signal, such as a 480p, 720p or 1080p formatted signal.

FIG. 1 presents a graphical representation of a general deinterlacing process as known in the art. In particular, a sequence of fields n, n+1, n+2, and n+3 are shown, in which the fields are in order of (Even, Odd, Even, Odd . . . ) Each of these fields is missing rows (scan lines) of pixels from a full frame. In particular, in Odd field n+3, missing lines are represented as dashed lines and a particular missing pixel 250 of one of these missing lines 252 is represented by a dot. Deinterlacing is essentially an interpolation problem under a special situation. Specifically, de-interlacing fills in the missing pixels in the missing lines of each field to make up a full frame.

Many deinterlacing algorithms produce undesirable artifacts that are visible to the viewer. The efficient and accurate de-interlacing of video signals is important to the implementation of many video devices, particularly video devices that are destined for home use. Further limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIG. 1 presents a graphical representation of a general de-interlacing process as known in the art.

FIGS. 2-4 present pictorial diagram representations of various video devices in accordance with embodiments of the present invention.

FIG. 5 presents a block diagram representation of a video device 40 in accordance with an embodiment of the present invention.

FIG. 6 presents a block diagram representation of a deinterlacer 135 in accordance with an embodiment of the present invention.

FIG. 7 presents a block diagram representation of a motion detection module 210 in accordance with an embodiment of the present invention.

FIG. 8 presents a block diagram representation of an adjacent field module 224 in accordance with an embodiment of the present invention.

FIG. 9 presents an example field sequence in accordance with an embodiment of the present invention.

FIG. 10 presents a graphical representation of the 33 possible orientations in accordance with an embodiment of the present invention.

FIG. 11 presents a window for 90 degree orientation detection in accordance with the present invention.

FIG. 12 presents a window for 8.13 degree orientation detection in accordance with the present invention.

FIG. 13 presents a graphical example of a line smoothness area in accordance with an embodiment of the present invention.

FIG. 14 presents an example for line smoothness measurement for an orientation of 33 degrees in accordance with an embodiment of the present invention.

FIG. 15 presents a block diagram representation of a post processing module 240 in accordance with an embodiment of the present invention.

FIG. 16 presents a flowchart representation of a method in accordance with an embodiment of the present invention.

FIG. 17 presents a flowchart representation of a method in accordance with an embodiment of the present invention.

FIG. 18 presents a flowchart representation of a method in accordance with an embodiment of the present invention.

### DETAILED DESCRIPTION OF THE INVENTION INCLUDING THE PRESENTLY PREFERRED EMBODIMENTS

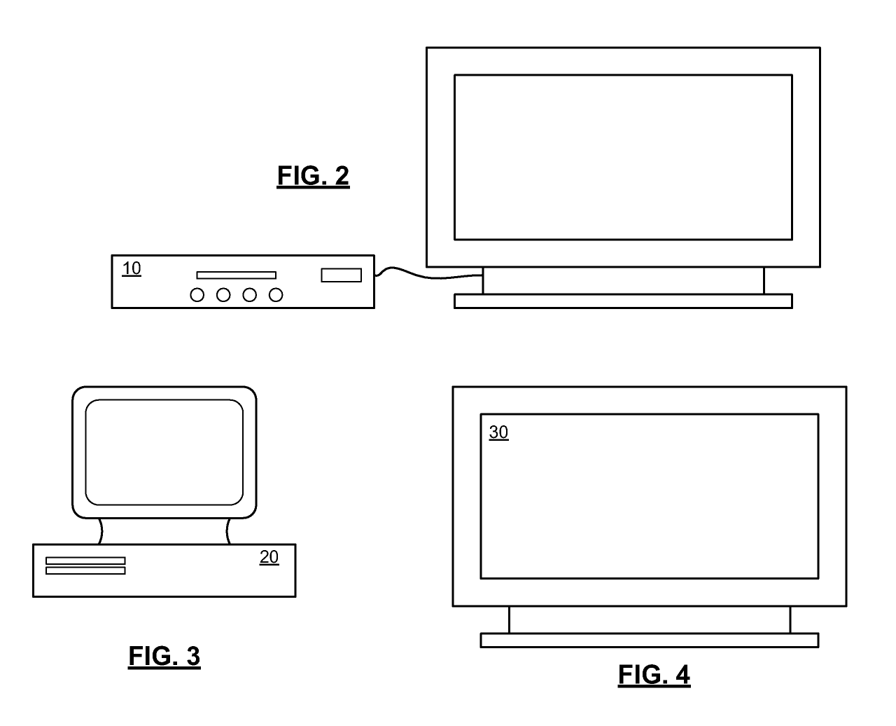

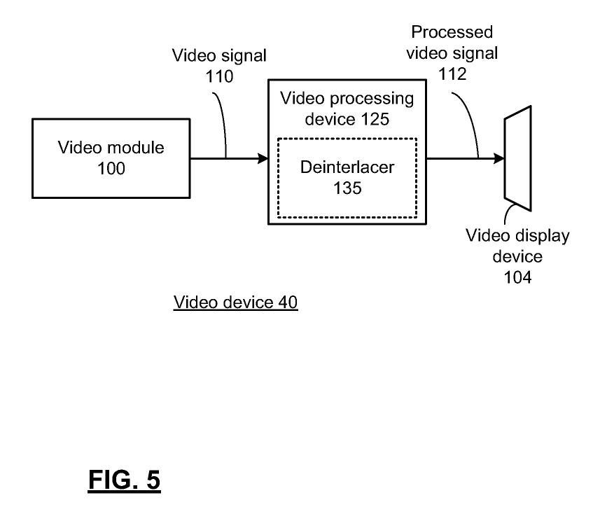

FIGS. 2-4 present pictorial diagram representations of various video devices in accordance with embodiments of the present invention. In particular, video device 10 represents a set-top box with or without built-in digital video recorder functionality, a stand alone digital video recorder, a digital video disc player or other video player, a video receiver, or other adjunct device that generates a deinterlaced video signal for a video display device. Device 10 includes a deinterlacer in accordance with the present invention. In addition computer 20 and video display device 30 illustrate other video devices that can incorporate a deinterlacer that includes one or more features or functions of the present invention. While these particular video devices are illustrated, the functions and features of the present invention can be incorporated in any video device that operates based on de-interlaced video content in accordance with the methods and systems described in conjunction with FIGS. 5-18 and the appended claims.

FIG. 5 presents a block diagram representation of a video device in accordance with an embodiment of the present invention. A video device 40 is shown that can be a video device 10, 20 or 30 or other video device. In particular, this video device 40 includes a video module 100, such as a television receiver, cable television receiver, satellite broadcast receiver, broadband modem, 3G transceiver, video player, video port or other input that is capable of generating or receiving one or more video signals 110. Video processing device 125 includes deinterlacer 135 and generates a processed video signal that can be a deinterlaced video signal or generated based on a deinterlaced video signal produced by deinterlacer 135. Video processing device 125 can be a video player, encoder, decoder, transcoder or other processing device that processes a video signal 110 into a processed video signal 112 for use by a separate or integrated video display device 104.

In an embodiment of the present invention, the video signal 110 is a broadcast video signal, such as a television signal, high definition television signal, enhanced definition television signal or other broadcast video signal that has been transmitted over a wireless medium, either directly or through one or more satellites or other relay stations or through a cable network, optical network or other transmission network. In addition, video signal 110 can be generated from a stored video file, played back from a recording medium such as a memory, magnetic tape, magnetic disk or optical disk, and/or can include a streaming video signal that is transmitted over a public or private network such as a local area network, wide area network, metropolitan area network or the Internet.

Video signal 110 can include an analog or digital video signal that is formatted in any of a number of interlaced video formats video formats. Processed video signal 112 can include a progressive scan video signal such as a 480p, 720p or 1080p signal or other analog or digital de-interlaced video signal.

Video display device 104 can include a television, monitor, computer, handheld device or other video display device that creates an optical image stream either directly or indirectly, such as by projection, based on decoding the processed video signal 112 either as a streaming video signal or by playback of a stored digital video file.

The deinterlacer 135 can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory. Such a memory may be a single memory device or a plurality of memory devices and can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

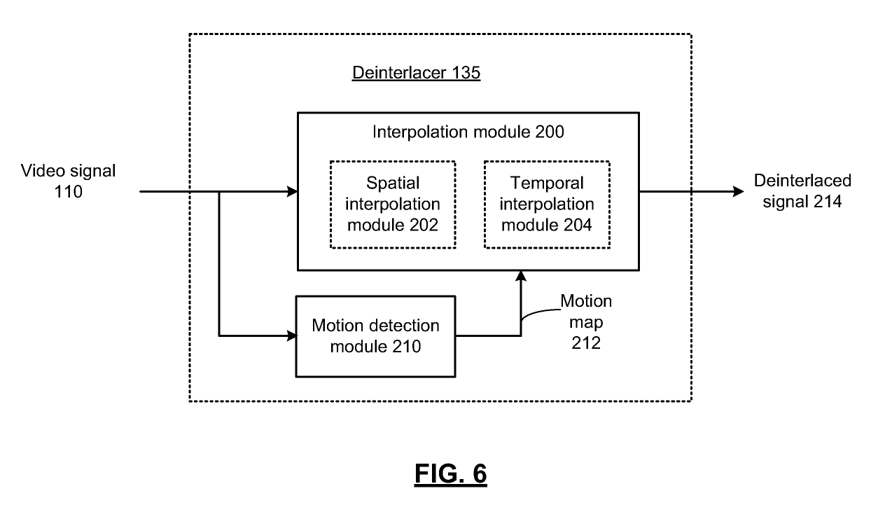

In accordance with the present invention, the deinterlacer 135 includes many optional functions and features described in conjunction with FIGS. 6-18 that follow.

FIG. 6 presents a block diagram representation of a deinterlacer 135 in accordance with an embodiment of the present invention. In particular, deinterlacer 135 includes a motion detection module 210 that generates a motion map 212 and an interpolation module 200 that is coupled to receive video signal 110 and the motion map 212. The interpolation module 200 generates a deinterlaced video signal 214 from the video signal, and is motion adaptive, based on the motion map 212. The interpolation module 200 includes a spatial interpolation module 202 that generates a spatially interpolated video signal having first pixel values and a temporal interpolation module 204 that generates a temporally interpolated video signal having second pixel values.

The interpolation module 200 generates the deinterlaced video signal 214 based on the first pixel values when corresponding pixel motion values of the motion map 212 are within a first range of values. In particular, for areas of a processed image that include pixels that exhibit motion or an amount of motion that is greater than some motion threshold, spatial interpolation is used to fill in the missing pixels. Further, interpolation module 200 generates the deinterlaced video signal 214 based on the second pixel values when the corresponding pixel motion values of the motion map 212 are within a second range of values. In this fashion, for areas of a processed image that include pixels that exhibit no motion or an amount of motion that is less than some motion threshold, temporal interpolation is used to fill in the missing pixels.

In an embodiment of the present invention, interpolation module 200 generates the deinterlaced video signal 214 by blending the first pixel values and the second pixel values when the corresponding pixel motion value has one of a third range of values. In this embodiment, the third range of values corresponds to low motion that falls between the first and second range of values. For areas of a processed image that include pixels that exhibit an amount of motion that is greater than the threshold that defines the upper boundary of the second range of values, but is less than the threshold that defines the lower boundary of the first range of values pixel values, results from spatial and temporal interpolation are blended to fill in the missing pixels. In particular, the blending itself can be interpolated monotonically, via a linear interpolation function. Or alternatively, the blending can be achieved non-linearly through a pre-defined look-up table. When motion values are closer to the boundary of the second range of values, temporal interpolation can dominate the blending. Similarly, when the amount of motion is closer to the boundary of the first range of values, spatial interpolation can dominate the blending.

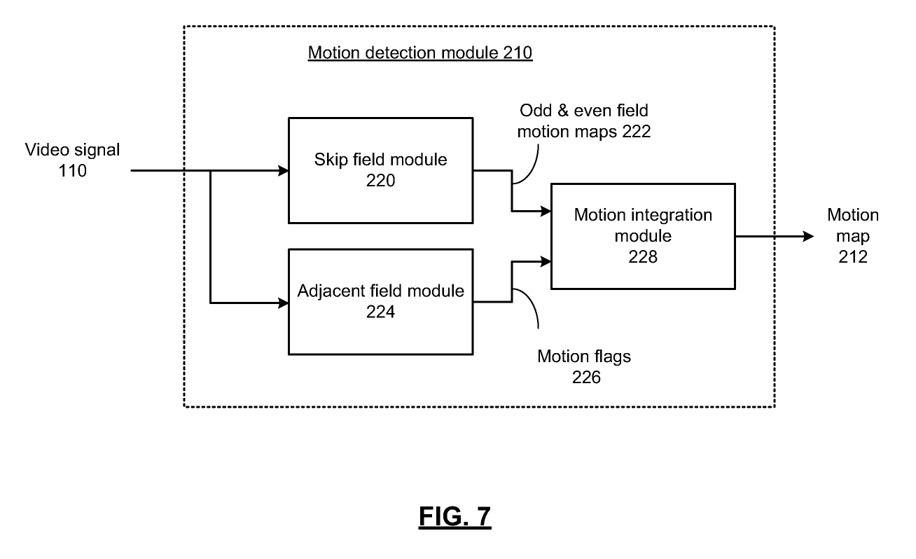

FIG. 7 presents a block diagram representation of a motion detection module 210 in accordance with an embodiment of the present invention. In particular, motion detection module 210 includes skip-field module 220 that generates odd and even field motion maps 222. In the odd field motion map, the pixel motion values are based on a comparison of pixel values in a first odd field of the video signal 110 to a second odd field of the video signal 110. In the even field motion map, the pixel motion values are based on a comparison of pixel values in a first even field of the video signal 110 to a second even field of the video signal 110.

The motion detection module 210 also includes an adjacent field module 224 that generates a plurality of motion flags 226 based on a comparison of pixel values between adjacent fields of the video signal 110. The motion integration module 228 generates the motion map 212 by integrating the odd and even field motion map 222 and the plurality of motion flags 226. In particular, each of the motion flags correspond to one of the pixel motion values. The motion integration module 228 increases a pixel motion value when the corresponding motion flag indicates motion.

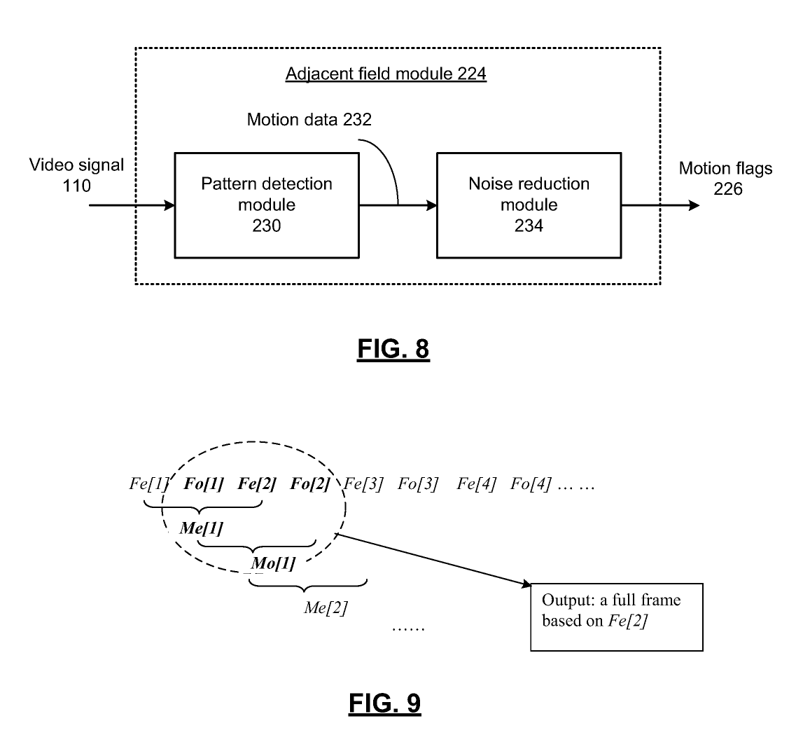

FIG. 8 presents a block diagram representation of an adjacent field module 224 in accordance with an embodiment of the present invention. In particular, pattern detection module 230 generates motion data 232 by detecting alternating intensity patterns in the adjacent fields of the video signal 110 and the motion flags 226 are based on the motion data 232. A noise reduction module 234 modifies the motion data 232 to eliminate isolated motion data, when isolated motion data is contained in the motion data 232 and/or modifies the motion data 232 based on at least one of: a morphological erosion, and a morphological dilation.

The operation of motion detection module 210 and interpolation module 200 as presented in conjunction with FIGS. 6-8 can be described in conjunction with the following example presented in conjunction with FIGS. 9-14 that presents several optional functions and features. In this example, the video signal 110 is in YUV format. The sampling rate of the three components Y:U:V can be different, for example, 4:2:2 or 4:2:0. The primary component is Y. In this example, the Y component is used as the default. Also, consider F represents field, and FR represents frame. Fe represents an even field, and Fo represents odd field. F(x,y,i) represents the pixel (x,y) in field i. M represents a field motion map, Me represents an even motion map, i.e., the motion map from two even fields, and Mo represents odd motion map, i.e., the motion map from two odd fields.

Considering the example shown in FIG. 9, the motion detection module 210 takes three consecutive fields (two odds one even) to generate an odd motion map; and another three fields (two evens and one odd) to generate an even motion map. Each time, only three fields are accessed, and the first field is discarded when generating the next motion map. The motion map that was previously generated can be stored, thus only three fields and two field motion maps are required for the interpolation by interpolation module 200. Fo[1], Fe[2], Fo[2] and Mo[1], Me[1] can be used for interpolation of the missing pixels in Fe[2] in order to form a full frame FR corresponding to Fe[2].

Motion detection module 210 generates the odd field motion map and even field motion map in the same way. Thus, three consecutive fields can be considered as the input without identifying odd or even.
Input: Three consecutive fields: F[n−1], F[n], F[n−2], where both F[n−1] and F[n+1] can be the same type (Odd/Even) and F[n] is another type (Even/Odd)
Output: An odd/even motion map where each pixel has four bits indicating the level of motion (0 to 15). It should be noted that greater or fewer bits may be used. The use of more bits gives better capability to show different motion levels.
   Skip field module 220 detects motion by comparing the pixels in the same location in two same fields (odd fields or even fields) such as F[n−1] and F[n+1]. To determine whether a pixel is in motion, a 3×3 block surrounding the pixel (x,y) is examined as shown in Table 1.

TABLE 1
3 × 3 Motion generation block

| | | |
|---|---|---|
| (x − 1, y − 1) | (x, y − 1) | (x + 1, y − 1) |
| (x − 1, y) | (x, y) | (x + 1, y) |
| (x − 1, y + 1) | (x, y + 1) | (x + 1, y + 1) |

Differences can be calculated based on the following equation:

$$Diff ( x , y , n ) = ( ( {\sum }_{i = - 1}^{l} ( {\sum }_{j = - 1}^{1} \vert \begin{matrix}F [ \begin{matrix}( x + i ) , \\ ( y + j ) , ( n - 2 )\end{matrix} ] - \\ F [ ( x + i ) , ( y + j ) , n ]\end{matrix} \vert * ( Weight ) ) )$$

Where F[a,b,c] represents the Y component of pixel row=a, column=b and field=c, and where the Weight is shown in Table 2.

TABLE 2
Weights for motion generation block

| | | |
|---|---|---|
| 1 | 1 | 1 |
| 1 | 2 | 1 |
| 1 | 1 | 1 |

The value of motion level for pixel (x,y) is then quantized as below, thus the number of bits in the motion map is 4 which yields a maximum value of 15 for each pixel motion value.

$$M ( x , y , n ) = \{ \begin{matrix}\frac{Diff ( x , y , n )}{32} & if Diff ( x , y , n ) < 512 \\ 15 & otherwise\end{matrix}$$

In the boundary area, there is no 3×3 neighborhood available. In an embodiment of the present invention, the skip field module 220 applies the equation only on the area of:

[1, W−2]×[1, H−2]

where the whole field has the area of [0, W−1]×[0, H−1] with W as its width and H as its height. The values on the first line/column and last line/column can be set to zero.

Adjacent field module 224 uses two adjacent different fields (odd and even, or even and odd) to detect the high frequency part caused by motion. This is especially useful in conditions of high motion when the pixel difference in consecutive odd or even fields is not able to detect motion. In this example, adjacent field module 224 uses both F[n−1] and F[n], and F[n] and F[n+1] to detect motion based on nearby pixels in several local windows presented in Table 3.

TABLE 3
Adjacent field windows

| | | | | | |
|---|---|---|---|---|---|
| x − 1, y − 1 | x, y − 1 | x + 1, y − 1 | | | F[n − 1] |
| x − 1, y | x, y | x + 1, y | | | F[n] |
| x − 1, y + 1 | x, y + 1 | x + 1, y + 1 | | | F[n − 1] |
| x − 1, y − 1 | x, y − 1 | x + 1, y − 1 | | | F[n − 1] |
| | x, y | x + 1, y | x + 2, y | | F[n] |
| | | x + 1, y + 1 | x + 2, y + 1 | x + 3, | F[n − 1] |
| | | | | y + 1 | |
| | | x + 1, y − 1 | x + 2, y − 1 | x + 3, | F[n − 1] |
| | | | | y − 1 | |
| | x, y | x + 1, y | x + 2, y | | F[n] |
| x − 1, y + 1 | x, y + 1 | x + 1, y + 1 | | | F[n − 1] |
| x − 1, y | x, y | x + 1, y | | | F[n] |
| x − 1, y + 1 | x, y + 1 | x + 1, y + 1 | | | F[n − 1] |
| x − 1, y + 2 | x, y + 2 | x + 1, y + 2 | | | F[n] |
| x − 1, y − 1 | x, y − 1 | x + 1, y − 1 | | | F[n + 1] |
| x − 1, y | x, y | x + 1, y | | | F[n] |
| x − 1, y + 1 | x, y + 1 | x + 1, y + 1 | | | F[n + 1] |
| x − 1, y − 1 | x, y − 1 | x + 1, y − 1 | | | F[n + 1] |
| | x, y | x + 1, y | x + 2, y | | F[n] |
| | | x + 1, y + 1 | x + 2, y + 1 | x + 3, | F[n + 1] |
| | | | | y + 1 | |
| | | x + 1, y − 1 | x + 2, y − 2 | x + 3, | F[n + 1] |
| | | | | y − 1 | |
| | x, y | x + 1, y | x + 2, y | | F[n] |
| x − 1, y + 1 | x, y + 1 | x + 1, y + 1 | | | F[n + 1] |
| x − 1, y | x, y | x + 1, y | | | F[n] |
| x − 1, y + 1 | x, y + 1 | x + 1, y + 1 | | | F[n + 1] |
| x − 1, y + 2 | x, y + 2 | x + 1, y + 2 | | | F[n] |

Adjacent field module 224 detects vertical and diagonal lines to decide if there is a motion. For example, in the first window shown in Table 3, if the three pixels F[x−1,y−1,n−1], F[x−1,y,n] and F[x−1,y+1,n−1] follow the pattern of lower intensity, higher intensity, lower intensity, then it is possible that this phenomenon is caused by motion. Another pattern (higher intensity, lower intensity, higher intensity again) is the same. The assumption behind this idea is that the spatial correlation is destroyed by new content if there is motion, thus the pixels in the new field interrupts the local spatial smoothness in the previous field.

To improve the robustness, three lines are detected rather than a single line. Vertical lines are detected in the first window and diagonal lines detected in the second and third windows. In one mode of operation, adjacent field module 224 operates as described below:
1) Pattern detection module 230 examines the windows shown in Table 3; if the pixels follow any one of the following two patterns, then it is deemed that there is motion a motion data 232 is set for that pixel (labeled as 1) for the central pixel F[x,y,n]; if there is no motion the motion data 232 is reset (labeled as zero).

Taking the first line in the first window as example,
Lower-Higher-Lower pattern:

F[x−1,y−1,n−1]<F[x−1,y,n] AND

F[x−1,y+1,n−1]<F[x−1,y,n] AND

|F[x−1,y−1,n−1]−F[x−1,y+1,n−1]|<α AND

|F[x−1,y−1,n−1]−F[x−1,y,n]|>β AND

|F[x−1,y+1,n−1]−F[x−1,y,n]|>β

β=2|F[x−1,y−1,n−1]−F[x−1,y+1,n−1]|
Higher-Lower-Higher pattern:

F[x−1,y−1,n−1]>F[x−1,y,n] AND

F[x−1,y+1,n−1]>F[x−1,y,n] AND

|F[x−1,y−1,n−1]−F[x−1,y+1,n−1]|<α AND

|F[x−1,y−1,n−1]−F[x−1,y,n]|>β AND

|F[x−1,y+1,n−1]−F[x−1,y,n]|>β

β=2|F[x−1,y−1,n−1]−F[x−1,y+1,n−1]|

Where, α=15 is pre-defined threshold. When all the three vertical lines follow either one of the two patterns (Lower-Higher-Lower, or Higher-Lower-Higher), then F[x,y,n] is a motion pixel.
For the first line in the second window:
Lower-Higher-Lower pattern:

F[x−1,y−1,n−1]<F[x,y,n] AND

F[x+1,y+1,n−1]<F[x,y,n] AND

|F[x−1,y−1,n−1]−F[x+1,y+1,n−1]|<α AND

|F[x−1,y−1,n−1]−F[x,y,n]|>β AND

|F[x+1,y+1,n−1]−F[x,y,n]|>β

β=2|F[x−1,y−1,n−1]−F[x+1,y+1,n−1]|

Higher-Lower-Higher pattern:

F[x−1,y−1,n−1]>F[x,y,n] AND

F[x+1,y+1,n−1]>F[x,y,n] AND

|F[x−1,y−1,n−1]−F[x+1,y+1,n−1]|<α AND

|F[x−1,y−1,n−1]−F[x,y,n]|>β AND

|F[x+1,y+1,n−1]−F[x,y,n]|>β

β=2|F[x−1,y−1,n−1]−F[x+1,y+1,n−1]|

The same technique can be used for the other windows of Table 3. For boundaries, the same strategy can be applied as used in the skip field module 220, i.e., setting the boundary areas to zero and evaluating only the interior region where the boundaries are defined.
2). Noise reduction module 234 examines and possibly modifies the motion data 232 to prevent false motion detection from happening. Two steps can be used for this noise reduction.
a) Isolated noise reduction—If a group of one or two pixels in the motion data 232 is detected as motion pixel while its all other neighbors are not, then these motion pixels will be changed to no-motion pixels. The neighborhood window shown in table 4 can be used.

TABLE 4
Isolated noise reduction neighbor window

| | | | | |
|---|---|---|---|---|
| | (x − 1, y − 2) | (x, y − 2) | (x + 1, y − 2) | |
| (x − 2, | (x − 1, y − 1) | (x, y − 1) | (x + 1, y − 1) | (x + 2, y − 1) |
| y − 1) | | | | |
| (x − 2, y) | (x − 1, y) | (x, y) | (x + 1, y) | (x + 2, y) |
| (x − 2, | (x − 1, y + 1) | (x, y + 1) | (x + 1, y + 1) | (x + 2, y + 1) |
| y + 1) | | | | |
| | (x − 2, y + 2) | (x, y + 2) | (x + 2, y + 2) | |

b) Morphological noise reduction process—The motion data can also be processed by morphological operations to further remove noise. The set of the operations can be sequential: (i) Erosion (19-neighbor); and (ii) Dilation (19-neighbor). Specifically, Erosion (19-neighbor) is performed with a pixel with its neighbors (as illustrated in Table 5 below), if any one of its neighbors is a no-motion pixel, then the central pixel (x,y) is deemed to be no-motion pixel and the motion data is adjusted accordingly. Dilation is the opposite: if any one of its neighbors is a motion pixel, then the central pixel (x,y) is set as a motion pixel. The final adjusted motion data is set as the motion flags 226. Boundary areas can be handled as described above in the pattern detection module 230. It should be noted that erosion and dilation can be applied several times and in different order to eliminate different types of noise. For example, erosion first and then dilation can be applied as a first step, and a following step can be dilation first and then erosion.

TABLE 5
19 neighbor window

| | | | | |
|---|---|---|---|---|
| (x − 2, | (x − 1, y − 1) | (x, y − 1) | (x + 1, y − 1) | (x + 2, y − 1) |
| y − 1) | | | | |
| (x − 2, y) | (x − 1, y) | (x, y) | (x + 1, y) | (x + 2, y) |
| (x − 2, | (x − 1, y + 1) | (x, y + 1) | (x + 1, y + 1) | (x + 2, y + 1) |
| y + 1) | | | | |
| (x − 2, | (x − 1, y + 2) | (x, y + 2) | (x + 1, y + 2) | (x + 2, y + 2) |
| y + 2) | | | | |

Motion integration module 228 operates to integrate the odd and even field motion maps 222 from the skip field module 220 with the motion flags 226 from the adjacent field module 224. For example, if a motion flag 226 is set for a pixel, then the pixel motion value (the pixel difference) will raised up a certain number of levels, such as 3 levels, to a maximum of 15. The result is the final motion map 212.

It should be noted that motion detection nodule 210 can also be used to detect if two fields are identical (for 3:2 pull-down detection). The key for 3:2 pull-down detection is to find repeated fields. Therefore, deinterlacer 135 can simply count the number of pixels below a threshold in the motion map 226 or the odd and even field motion maps 222 to see if the two fields are almost the same—within some tolerance. The threshold can be chosen as a small number that is above the expected noise level.

Continuing with this example, interpolation module 200 operates in three basic modes, defined by the relationship of pixel motion values of the motion map 212 to low and high thresholds.
1) If there is significant motion detected, such as when a pixel motion value is above a high threshold, only spatial information is used.
2) If there is no motion detected, such as when the pixel motion value is zero or below some low threshold, only temporal information is used and the missing pixel can be filled by the average of the same pixel in the previous and next field. This is basically the concept of weaving.
3) If the detected motion level is low, such as when the pixel motion value is above the low threshold, but below the high threshold, temporal-spatial information is used. If the motion detection level is low, it is possible that the pixel is moving with slow motion or maybe the motion detection result is not reliable. In either case, a blending is needed to get balanced result in which both spatial and temporal information is weighted according to the motion level. The higher the motion level, the more spatial information is used; the lower the motion level, the more temporal information is used.

In an embodiment of the present invention, the spatial interpolation module 202 generates pixel values for an image within a window or other area of the image based on an interpolation along a best orientation, an interpolation along a local gradient, and/or a weighted vertical interpolation. In operation, the spatial interpolation module can detect a best orientation. For example, one of 33 possible orientations can be detected. There are 16 orientations between 90 degree and 0 degree (indicated as 7.12, 7.59, 8.13, . . . 45, 64) and 16 orientations between 90 degree to 180 degree (indicated as −7.12, −7.59, −8.13, . . . −45, −64). The smallest orientation is

$${tan}^{- 1} \frac{2}{16} = 7.12 °$$

in the full frame domain; i.e., 16 pixels in horizontal and 2 pixels in vertical direction. This is equivalent to

$${tan}^{- 1} \frac{1}{16} = 3.57 °$$

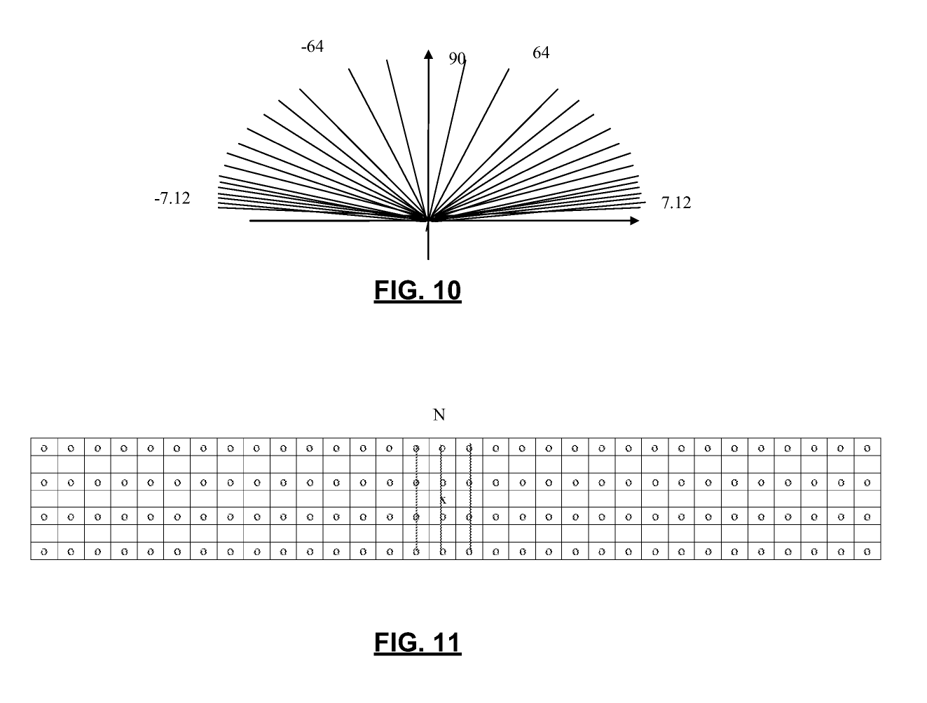

in the field domain. FIG. 10 presents a graphical representation of the 33 possible orientations in accordance with an embodiment of the present invention. It should be noted that note that the angles are not drawn to scale.

To detect the orientation, the spatial interpolation module 202 calculates the weighted absolute difference along each orientation. The smaller the difference, the more likely the true orientation is detected. The spatial interpolation module 202 uses a 4×32 neighborhood to calculate the gradient along each orientation.

FIG. 11 presents window used for 90 degree orientation detection in accordance with the present invention. The current pixel is indicated by an “x” and other pixel locations indicted by “o”. The 90 degree orientation is indicated by the three vertical lines.

The formula for the 90 degree orientation is given below:

D₉₀¹=2|pL(0,N)−pL(1,N)|+4|pL(1,N)−pL(2,N)|+2|pL(2,N)−pL(3,N)|

D₉₀²=|pL(0,N−1)−pL(1,N−1)|+2|pL(1,N−1)−pL(2,N−1)|+|pL(2,N−1)−pL(3,N−1)|

D₉₀³=|pL(0,N+1)−pL(1,N+1)|+2|pL(1,N+1)−pL(2,N+1)|+|pL(2,N)−pL(3,N+1)|

D₉₀=(D₉₀¹+D₉₀¹+D₉₀¹)>>4

Where, pL(x,y) means the pixel intensity (Y component) in the location of (x,y) in the current field. pL(x,N) means the pixel on the central location in horizontal direction (y direction).

FIG. 12 presents a window used for 8.13 degree orientation detection in accordance with the present invention. The orientation direction is indicated by the diagonal lines. The formula for the calculation of 8.13 degree orientation is given below.

$${D}_{8.13}^{1} = \vert pL ( 0 , N + 1 ) - pL ( 1 , N - 13 ) \vert$$

$${D}_{8.13}^{2} = \vert pL ( 0 , N + 2 ) - pL ( 1 , N - 12 ) \vert$$

$$⋮$$

$${D}_{8.13}^{14} = \vert pL ( 0 , N + 14 ) - pL ( 1 , N ) \vert + \vert pL ( 1 , N ) - pL ( 2 , N - 14 ) \vert$$

$$⋮$$

$${D}_{8.13}^{16} = \vert \begin{matrix}pL ( 0 , N + 16 ) - \\ pL ( 1 , N + 2 )\end{matrix} \vert + \vert \begin{matrix}pL ( 1 , N + 2 ) - \\ pL ( 2 , N - 12 )\end{matrix} \vert$$

$${D}_{8.13}^{17} = \vert pL ( 1 , N ) - pL ( 2 , N - 14 ) \vert$$

$${D}_{8.13}^{18} = \vert pL ( 1 , N + 1 ) - pL ( 2 , N - 13 ) \vert$$

$$⋮$$

$${D}_{8.13}^{24} = 4 \vert pL ( 1 , N + 7 ) - pL ( 2 , N - 7 ) \vert$$

$$⋮$$

$${D}_{8.13}^{30} = \vert \begin{matrix}pL ( 1 , N + 13 ) - \\ pL ( 2 , N - 1 )\end{matrix} \vert + \vert \begin{matrix}pL ( 2 , N - 1 ) - \\ pL ( 3 , N - 15 )\end{matrix} \vert$$

$$⋮$$

$${D}_{8.13}^{32} = \vert \begin{matrix}pL ( 1 , N + 16 ) - \\ pL ( 2 , N + 2 )\end{matrix} \vert + \vert \begin{matrix}pL ( 2 , N + 2 ) - \\ pL ( 3 , N - 12 )\end{matrix} \vert ⋮$$

$$⋮$$

$${D}_{8.13}^{43} = \vert pL ( 2 , N + 13 ) - pL ( 3 , N - 1 ) \vert$$

$${D}_{8.13} = \frac{{\sum }_{i = 1}^{43} {D}_{8.13}^{i}}{64}$$

The calculation for other orientations can be found in a similar fashion: calculate the weighted absolute difference and normalize it. The central line(s) is weighted more than the other lines. There are two reasons for that: 1) the central line(s) is closer to the missing pixel thus it should be given more weights; 2) the weights are designed to make division by 2^{x} in order to be hardware friendly.

The spatial interpolation module 202 can perform interpolation along the best detected orientation. However, because of the small vertical neighborhood, the detected orientation is usually not very reliable. Also, the pixel far from the central pixel has relatively weak correlation comparing with its close neighbors, therefore, in many cases, the best orientation judged only by its least difference value may be wrong. This is especially true for small angle orientations (imagine that the two pixels which are 14 pixels far away from two sides will be used for interpolation, risk does exist). For this purpose, a smoothness measure is introduced based on the following observation; if there is a line with a small angle orientation, then it usually has a relatively smooth intensity change within the line segment in the horizontal direction except the boundary between the line and the background.

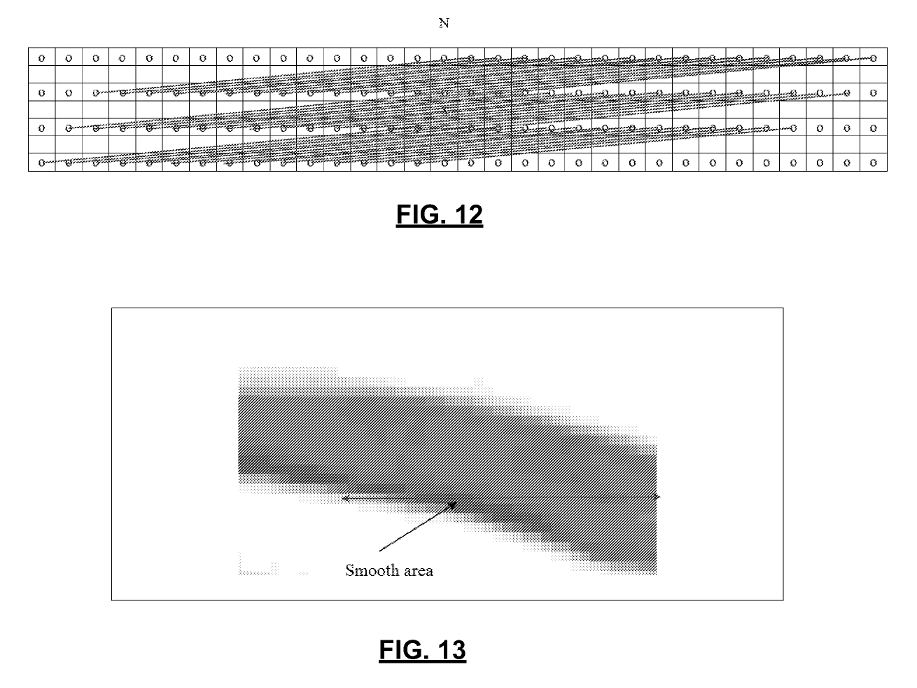

FIG. 13 presents a graphical example of a line smoothness area in accordance with an embodiment of the present invention. In particular, the line smoothness measure is designed for diagonal orientation (especially with small angle), so there is no line smoothness measure calculation for orientation of 90, 64, −64 degrees. The line smoothness measurement is calculated by the difference of horizontal gradient in the orientation detection area.

FIG. 14 presents an example for line smoothness measurement for an orientation with 33 degree in accordance with an embodiment of the present invention. In this figure, the 33 degree orientation is indicated by horizontal lines. In a similar fashion to orientation detection, the gradient closer to the missing pixels may be given more weights such that the division is by power of 2 in order to be hardware friendly. The calculation of line smoothness measurement can be arranged such that the line smoothness of the diagonal orientation with smaller angle can use the previous result. Then no duplicated calculation is needed. The formula below gives an example of the calculation of line smoothness measurement for 33 degree.

$${HG}_{33}^{0} = \vert \begin{matrix}pL ( 0 , N + 1 ) - \\ pL ( 0 , N + 2 )\end{matrix} \vert + \vert \begin{matrix}pL ( 0 , N + 2 ) - \\ pL ( 0 , N + 3 )\end{matrix} \vert + … + \vert \begin{matrix}pL ( 0 , N + 8 ) - \\ pL ( 0 , N + 9 )\end{matrix} \vert$$

$${HG}_{33}^{1} = \vert \begin{matrix}pL ( 0 , N - 2 ) - \\ pL ( 0 , N - 1 )\end{matrix} \vert + \vert \begin{matrix}pL ( 0 , N - 1 ) - \\ pL ( 0 , N )\end{matrix} \vert + … + \vert \begin{matrix}pL ( 0 , N + 5 ) - \\ pL ( 0 , N + 6 )\end{matrix} \vert$$

$${HG}_{33}^{2} = \vert \begin{matrix}pL ( 0 , N - 5 ) - \\ pL ( 0 , N - 4 )\end{matrix} \vert + \vert \begin{matrix}pL ( 0 , N - 4 ) - \\ pL ( 0 , N - 3 )\end{matrix} \vert + … + \vert \begin{matrix}pL ( 0 , N + 2 ) - \\ pL ( 0 , N + 3 )\end{matrix} \vert$$

$${HG}_{33}^{3} = \vert \begin{matrix}pL ( 0 , N - 8 ) - \\ pL ( 0 , N - 7 )\end{matrix} \vert + \vert \begin{matrix}pL ( 0 , N - 7 ) - \\ pL ( 0 , N - 6 )\end{matrix} \vert + … + \vert \begin{matrix}pL ( 0 , N - 1 ) - \\ pL ( 0 , N )\end{matrix} \vert$$

$${HG}_{33} = {\sum }_{i = 0}^{3} ( {HG}_{33}^{i} ) >> 5$$

A general horizontal gradient HGG can also calculated for the neighborhood:

$$HGG = {\sum }_{j = 0}^{3} {v}_{ij} {\sum }_{i = - 6}^{6} {w}_{i} \vert pL ( j , N + i ) - pL ( j , N + i + 1 ) \vert >> 5$$

$${w}_{i} = \{ \begin{matrix}2 & when i = - 1 , 0 \\ 1 & Otherwise\end{matrix} \\ {v}_{ij} = \{ \begin{matrix}1 & when j = 1 , 2 or i = - 1 , 0 \\ 0 & Otherwise\end{matrix}$$

After calculating the orientation, line smoothness measurement, and general horizontal gradient, the spatial interpolation module 202 can apply interpolation along the best orientation. Possible interpolation scenarios can be classified in four types:

1) Smooth area

2) Line segment area

3) Texture area

4) Other area

For a smooth area, the spatial interpolation module 202 can apply a weighted average using a small 2×3 neighborhood. For line segment area, spatial interpolation module 202 can interpolate the missing pixel along the best orientation. If the conditions fail for the above two situations, spatial interpolation module 202 can use a 2×3 neighborhood to determine if a fine and sharp texture region and use an edge adaptive method in this small neighborhood when the edge is strong. Otherwise, spatial interpolation module 202 can use weighted vertical interpolation for any area that does not belong to any one of these other three classes.

A smooth area can be detected by checking if all the pixels in a 4×5 neighborhood have similar intensity value (less than 15). The spatial interpolation for this smooth area is a weighted average for smooth area:

$$X = ( ( {\sum }_{i = - 1}^{1} {\sum }_{j = 1}^{2} ( pL ( N + i , j ) * {W}_{i , j} ) >> 3$$

using 2×3 kernel (W_{i,j}) as the table below:

TABLE 6
Smooth area weights

| | | |
|---|---|---|
| 1 | 2 | 1 |
| | X | |
| 1 | 2 | 1 |

When strong orientation is detected, usually it indicates a line segment exists. However, when the neighborhood is small in vertical direction, the detection may be wrong. Therefore, several conditions can be used as constraints to increase the likelihood that the orientation detection is correct. For example, if the number of small orientations is greater than a small orientation threshold, then there is a strong hint that this is “S” texture area rather then a line segment area; if the minimum orientation is larger than a minimum orientation threshold, then there is not likely be a line segmentation area; if the correspondent line smoothness of the minimum orientation is greater than line smoothness threshold, then we do not trust that the minimum orientation is a line segment.

The list below presents example interpolations along a detected orientation. Note that interpolation along the detected orientation is only performed after the conditions are checked as discussed above.

$$1 ) 90 degree ( vertical interpolation ) \\ X = \frac{pL ( 1 , N ) + pL ( 2 , N )}{2} \\ 2 ) 64 degree \\ X = \frac{\begin{matrix}2 * pL ( 1 , N ) + pL ( 2 , N - 1 ) + \\ pL ( 1 , N + 1 ) + 2 * pL ( 2 , N )\end{matrix}}{6} \\ 3 ) - 64 degree X = \frac{\begin{matrix}2 * pL ( 1 , N ) + pL ( 2 , N + 1 ) + \\ pL ( 1 , N - 1 ) + 2 * pL ( 2 , N )\end{matrix}}{6} \\ 4 ) 45 degree \\ X = \frac{pL ( 1 , N + 1 ) + pL ( 2 , N - 1 )}{2} \\ 5 ) - 45 degree X = \frac{pL ( 1 , N - 1 ) + pL ( 2 , N + 1 )}{2} \\ 6 ) 33 degree to 7.5 degree ; - 33 degree to - 7.5 degree$$

$$X = \frac{\begin{matrix}pL ( 1 , N + ix ) + \\ pL ( 2 , N - ix 2 ) + pL ( 1 , N + ix 2 ) + pL ( 2 , N - ix )\end{matrix}}{4}$$

where, ix and ix2 are the corresponding index along the minimum orientation. For 33, 26, . . . 7.5, ix=1, 2, 3, 4, . . . 8; ix2=2, 2, 4, 4, 6, 6, . . . , 8, 8. For −33, −26, . . . −7.5, ix=−1, −2, −3, −4, . . . −8; ix2=−2, −2, −4, −4, −6, −6, . . . , −8, −8.

The spatial interpolation module 202 can perform texture interpolation as presented below:
X—pixel for interpolating
P1, P2, P3, P4—pixels in the spatial 2×3 neighborhood (shown below)
qL—pixel corresponding to X in previous field
q_L—pixel corresponding to X in next field
   Pre-defined threshold values(registers):

Tn1=20

Tn2=40

Tn3=30

Tn4=15

### Procedure:

a. Calculate the gradient in a small 2×3 neighborhood shown below:

| | | |
|---|---|---|
| P0 | P1 | P2 |
| | X | |
| P3 | P4 | P5 |

d0=|p0−p5|

d1=|p1−p4|

d2=|p2−p3|
b. If d0<d1 AND d0<d2 AND abs(d0−d1)>Tn1 AND abs(d0−d2)>Tn1, then X=(P0+P1+P4+P5)/4
c. Else if d1<d0 AND d1<d2 AND abs(d1−d0)>Tn1 AND abs(d1−d2)>Tn1, then X=(P0+6*P1+P2+P3+6*P4+P5)/16
d. Else if d2<d0 AND d2<d1 AND abs(d2−d0)>Tn1 AND abs(d2−d1)>Tn1, then X=(P1+P2+P3+P4)/4
e. Else
   A←min(qL, q_L)
   B←min(P4, P1)
   C←max(qL, q_L)
   D←max(P4, P1)
if any one of the following conditions is true
   a. abs(qL−P1)>Tn2 AND abs(qL−P4)>Tn2 AND abs(q_L−P1)>Tn2 AND abs(q_L−P4)>Tn2
   b. abs(A−B)>Tn3 OR abs(C−D)>Tn3
   c. abs(P4−P1)<Tn4
   then

X=(P1+P4)/2
Else
   E=min(A, P1)
   F=min(E, P4)
   G=max(A, P1)
   H=max(G, P4)

X=(q_{—}L+P1+p4+qL−F−A)/2

As discussed above, when the motion map 212 indicates low motion level, the interpolation module 200 applies a blended temporal-spatial interpolation. If the pixel is not in moving according to the motion map 212, then the missing pixel is assigned the value of the same pixel location of the previous field. In boundary areas where the neighborhood is not large enough to applies one or more of the techniques listed above, a simplified version adaptive Bob/Weave can be applied. In particular, if the motion map pixel motion value is larger than 2, then Bob (i.e., vertical interpolation), otherwise, weave (i.e., average of the previous filed pixel and next field pixel).

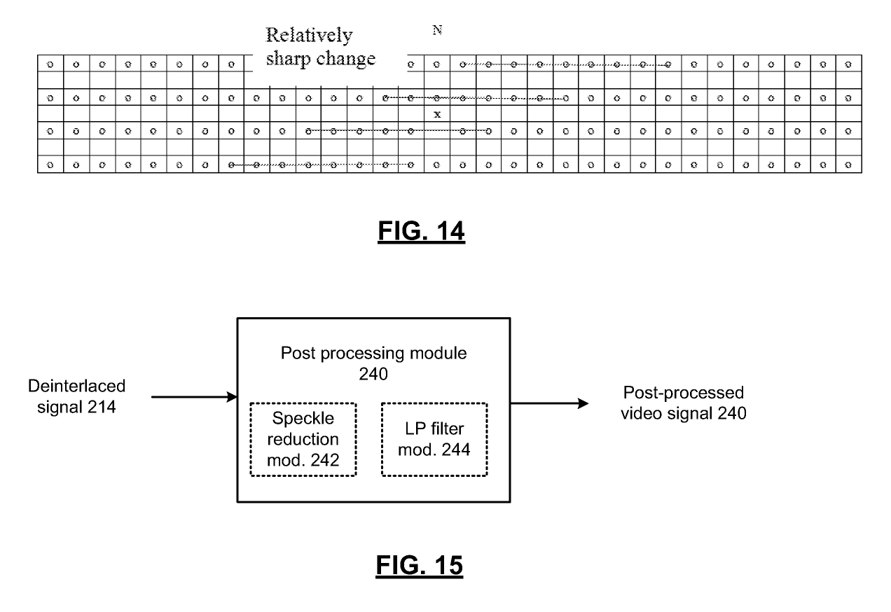

FIG. 15 presents a block diagram representation of a post processing module 240 in accordance with an embodiment of the present invention. In particular, deinterlacer 135 can include a post processing module that post processes the deinterlaced video signal 214 from the interpolation module to generate a post-processed video signal 240. The post processing module 240 can include a speckle reduction module 242 and/or a low pass filter module 244.

The post processing module 240 tries to further reduce noise—either from video signal 110 or from de-interlacing process. Therefore, both the original pixels and interpolated pixels can be used in this process. For example, speckle reduction module 242 can operate if the current pixel is different by more than some speckle reduction threshold from any one of its eight neighbors in a 3×3 neighborhood and replace the pixel with the average of its 8 neighbors. Low pass filter module 244 can also be applied to further reduce noise by spatial filtering. The kernel is shown in Table 8 below.

TABLE 8
Low pass filter coefficients

| | | |
|---|---|---|
| | ⅛ | |
| ⅛ | ½ | ⅛ |
| | ⅛ | |

While the description above has focused primarily on deinterlacing the Y component of a video signal 110, the U and V components can be deinterlaced by:
1) Following the same interpolation as used in conjunction with the Y component but using a decimated motion map 212 generated only from Y component, and a 4×32 interpolation window. For example, in 4:2:0 format, one pixel in the chroma (4:2:0) corresponds to 4 pixels in Luma. So an average of 2×2 is applied to generate a pixel in the decimated motion map used in chroma interpolation.
2) Whenever it is deemed as no motion in an area, check the difference in chroma before the interpolation. If the difference is larger than a chroma interpolation threshold, a vertical line average is used. Otherwise the same interpolation as luma is used.
3) A vertical low-pass filter can be added to further remove the color noise since color error is inherent with interlaced video in lower color sampling rate, i.e., 4:2:0.

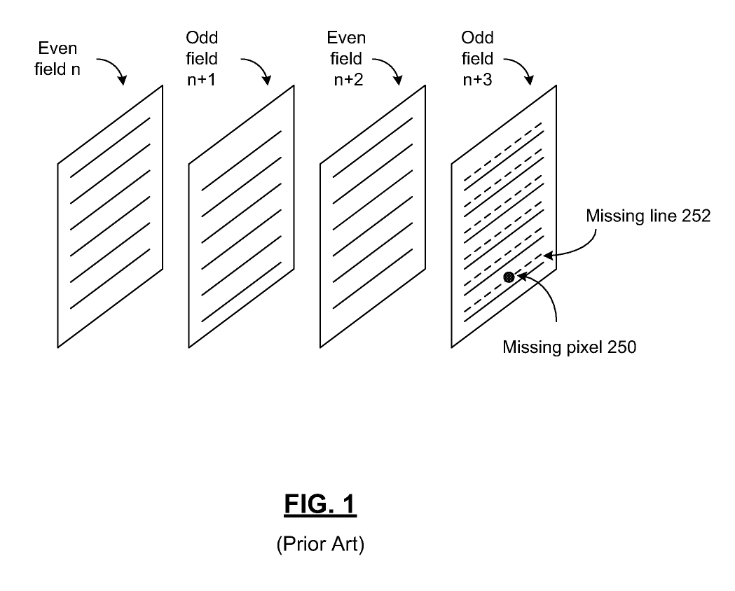

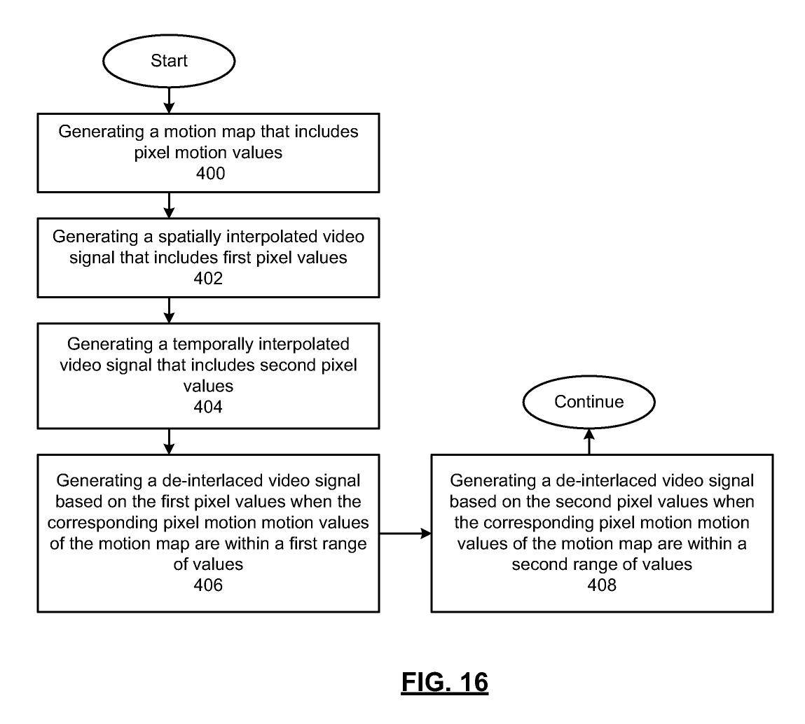

FIG. 16 presents a flowchart representation of a method in accordance with an embodiment of the present invention. In particular, a method is presented for use in conjunction with one or more of the features and functions described in association with FIGS. 1-15. In step 400, a motion map is generated that includes pixel motion values. In step 402, a spatially interpolated video signal is generated that includes first pixel values. In step 404, a temporally interpolated video signal is generated that includes second pixel values. In step 406, a deinterlaced video signal is generated based on the first pixel values when the corresponding pixel motion values of the motion map are within a first range of values. In step 408, the deinterlaced video signal is generated based on the second pixel values when the corresponding pixel motion values of the motion map are within a second range of values.

In an embodiment of the present invention, step 400 includes generating an odd field motion map wherein the plurality of pixel motion values are based on a comparison of pixel values in a first odd field of the video signal to a second odd field of the video signal, and generating an even field motion map wherein the plurality of pixel motion values are based on a comparison of pixel values in a first even field of the video signal to a second even field of the video signal. Step 400 can further include generating a plurality of motion flags based on a comparison of pixel values between adjacent fields of the video signal. The a plurality of motion data can be generated by detecting alternating intensity patterns in the adjacent fields of the video signal, wherein the plurality of motion flags are based on the motion data. The motion data can be modified to eliminate isolated motion data, when isolated motion data is contained in the motion data. The motion data can also be modified based on at least one of: a morphological erosion, and a morphological dilation.

Step 400 can include generating the motion map by integrating the odd-field motion map, the even-field motion map and the plurality of motion flags. The plurality of motion flags can each correspond to one of the plurality of pixel motion values and integrating the odd-field motion map, the even-field motion map and the plurality of motion flags can include increasing selected ones of the pixel motion values when the corresponding ones of the plurality of motion flags indicate motion.

Step 402 can generates the first pixel values within an area based on at least one of: an interpolation along a best orientation, an interpolation along a local gradient, and a weighted vertical interpolation. The deinterlaced signal can include a Y component, a U component and a V component and the motion map can be generated based on the Y component.

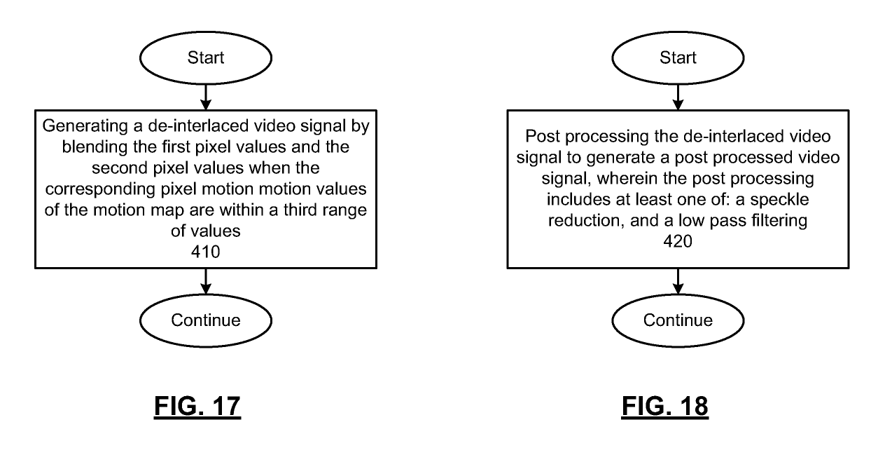

FIG. 17 presents a flowchart representation of a method in accordance with an embodiment of the present invention. In particular a method is presented for use in conjunction with the method of claim 16. In step 410, the deinterlaced video signal is generated by blending the first pixel values and the second pixel values when the corresponding pixel motion value has one of a third range of values.

FIG. 18 presents a flowchart representation of a method in accordance with an embodiment of the present invention. In particular a method is presented for use in conjunction with the methods of claim 16 and 17. In step 420, the deinterlaced video signal is post processed to generate a post-processed video signal, wherein the post processing includes at least one of: a speckle reduction, and a low pass filtering.

While particular combinations of various functions and features of the present invention have been expressly described herein, other combinations of these features and functions are possible that are not limited by the particular examples disclosed herein are expressly incorporated in within the scope of the present invention.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As the term module is used in the description of the various embodiments of the present invention, a module includes a functional block that is implemented in hardware, software, and/or firmware that performs one or module functions such as the processing of an input signal to produce an output signal. As used herein, a module may contain submodules that themselves are modules.

Thus, there has been described herein an apparatus and method, as well as several embodiments including a preferred embodiment, for implementing a deinterlacer. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A deinterlacer comprising:
an interpolation module, coupled to receive a video signal and a motion map, that generates a deinterlaced video signal, the interpolation module including:
a spatial interpolation module that generates a spatially interpolated video signal having first pixel values; and
a temporal interpolation module that generates a temporally interpolated video signal having second pixel values;
wherein the interpolation module generates the deinterlaced video signal based on the first pixel values when corresponding pixel motion values of the motion map are within a first range of values and that generates the deinterlaced video signal based on the second pixel values when the corresponding pixel motion values of the motion map are within a second range of values.

2. The deinterlacer of claim 1 further comprising:
a motion detection module, coupled to the interpolation module, that generates the motion map, wherein the motion detection module includes:
skip-field module that generates an odd field motion map wherein the plurality of pixel motion values are based on a comparison of pixel values in a first odd field of the video signal to a second odd field of the video signal and that generates an even field motion map wherein the plurality of pixel motion values are based on a comparison of pixel values in a first even field of the video signal to a second even field of the video signal.

3. The deinterlacer of claim 2 wherein the motion detection module further includes:
an adjacent field module that generates a plurality of motion flags based on a comparison of pixel values between adjacent fields of the video signal.

4. The deinterlacer of claim 3 wherein the adjacent field module includes:
a pattern detection module that generates motion data by detecting alternating intensity patterns in the adjacent fields of the video signal, wherein the plurality of motion flags are based on the motion data.

5. The deinterlacer of claim 4 wherein the adjacent field module further includes;
a noise reduction module that modifies the motion data to eliminate isolated motion data, when isolated motion data is contained in the motion data.

6. The deinterlacer of claim 4 wherein the adjacent field module further includes;
a noise reduction module that modifies the motion data based on at least one of: a morphological erosion, and a morphological dilation.

7. The deinterlacer of claim 3 wherein the motion detection module further includes:
a motion integration module that generates the motion map by integrating the odd-field motion map, the even-field motion map and the plurality of motion flags.

8. The deinterlacer of claim 7 wherein the plurality of motion flags each correspond to one of the plurality of pixel motion values and the motion integration module increases selected ones of the pixel motion values when the corresponding ones of the plurality of motion flags indicate motion.

9. The deinterlacer of claim 1 wherein the interpolation module generates the deinterlaced video signal by blending the first pixel values and the second pixel values when the corresponding pixel motion value has one of a third range of values.

10. The deinterlacer of claim 1 wherein the spatial interpolation module generates the first pixel values within an area based on at least one of: an interpolation along a best orientation, an interpolation along a local gradient, and a weighted vertical interpolation.

11. The deinterlacer of claim 1 further comprising:
a post processing module, coupled to the interpolation module, that post processes the deinterlaced video signal to generate a post-processed video signal, wherein the post processing module includes at least one of: a speckle reduction module, and a low pass filter module.

12. The deinterlacer of claim 1 wherein the deinterlaced signal includes a Y component, a U component and a V component and wherein the motion map is generated based on the Y component.

13. A method comprising:
generating a motion map that includes pixel motion values;
generating a spatially interpolated video signal that includes first pixel values;
generating a temporally interpolated video signal that includes second pixel values;
generating a deinterlaced video signal based on the first pixel values when the corresponding pixel motion values of the motion map are within a first range of values; and
generating the deinterlaced video signal based on the second pixel values when the corresponding pixel motion values of the motion map are within a second range of values.

14. The method of claim 13 wherein generating the motion map includes:
generating an odd field motion map wherein the plurality of pixel motion values are based on a comparison of pixel values in a first odd field of the video signal to a second odd field of the video signal; and
generating an even field motion map wherein the plurality of pixel motion values are based on a comparison of pixel values in a first even field of the video signal to a second even field of the video signal.

15. The method of claim 14 wherein generating the motion map further includes:
generating a plurality of motion flags based on a comparison of pixel values between adjacent fields of the video signal.

16. The method of claim 15 wherein generating the plurality of motion flags includes:
generating motion data by detecting alternating intensity patterns in the adjacent fields of the video signal, wherein the plurality of motion flags are based on the motion data.

17. The method of claim 16 wherein generating the plurality of motion flags further includes;
modifying the motion data to eliminate isolated motion data, when isolated motion data is contained in the motion data.

18. The method of claim 16 wherein generating the plurality of motion flags further includes;
modifying the motion data based on at least one of: a morphological erosion, and a morphological dilation.

19. The method of claim 15 wherein generating the motion map further includes:
generating the motion map by integrating the odd-field motion map, the even-field motion map and the plurality of motion flags.

20. The method of claim 19 wherein the plurality of motion flags each correspond to one of the plurality of pixel motion values and integrating the odd-field motion map, the even-field motion map and the plurality of motion flags includes increasing selected ones of the pixel motion values when the corresponding ones of the plurality of motion flags indicate motion.

21. The method of claim 13 further comprising;
generating the deinterlaced video signal by blending the first pixel values and the second pixel values when the corresponding pixel motion value has one of a third range of values.

22. The method of claim 13 wherein generating the spatially interpolated video signal generates the first pixel values within an area based on at least one of: an interpolation along a best orientation, an interpolation along a local gradient, and a weighted vertical interpolation.

23. The method of claim 13 further comprising:
post processing the deinterlaced video signal to generate a post-processed video signal, wherein the post processing includes at least one of: a speckle reduction, and a low pass filtering.

24. The method of claim 13 wherein the deinterlaced signal includes a Y component, a U component and a V component and wherein the motion map is generated based on the Y component.
